(19) United States
(12) Patent Application Publication
(10) Pub. No.: US 2005/0240657 A1
(43) Pub. Date: Oct. 27, 2005

(54) Web page upload system, computer program, and recording medium

(75) Inventors: Naoya Yamaguchi, Tokyo (JP); Kenji Goshima, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Tokyo (JP)

(21) Appl. No.: 10/523,508

(22) PCT Filed: Jul. 31, 2003
(86) PCT No.: PCT/JP03/09766

§ 371 Date: Feb. 4, 2005

(30) Foreign Application Priority Data
Aug. 6, 2002 (JP) 2002-228201

(51) Int. Cl. G06F 15/16

(52) U.S. Cl. 709/217; 709/204

(57) ABSTRACT

It is an object of the present invention to provide a web page uploading system which enables easy editing and uploading of a web page without specifying an upload area to which the web page is to be uploaded each time the web page is to be uploaded. When web editing software is launched while a web page is being browsed a client computer obtains data regarding an area in a web server where the web page is stored and the web page. When the web page edited by the web editing software is to be uploaded by the client computer, the client computer uploads the web page to the registered area in the web servers.

### BACKGROUND OF THE INVENTION

1. Field of the Invention

The present invention relates to a web page uploading system and particularly, to a web page uploading system which enables easy uploading of an edited web page without specifying an upload area to which the web page is to be uploaded, a computer program for achieving the uploading system and a recording medium in which the computer program is stored.

2.Description of the Related Art

Web contents produced using an HTML or the like are conventionally uploaded as follows. The web contents are first produced using a software tool for web page editing (hereinafter referred to as a “web editing program”) and the thus produced web contents are stored on a local hard disk of a client computer. An FTP tool of an FTP program, a web editing program or the like is next launched for uploading the web contents to a web server. Then, a storage area (in a local hard disk) of the web contents to be uploaded is specified by operating the FTP tool and an upload area (a web server) of the web contents is specified. Thereafter, when file transfer is instructed, the web contents are uploaded into a predetermined folder in the web server.

However, the above uploading method has the following disadvantages.

Specifically, when web contents are first to be uploaded to a web server, it is necessary to directly specify an upload area of the web server where the web contents are to be uploaded. For example, in the case where the URL (Uniform Resource Locator) designating a specific area in a web server on the network is represented as “http://www.abc.ne.jp/˜yama” and web contents are to be uploaded to this area, it is necessary to input this character string to enter the URL in the FTP tool. Further, in this case, the creator of the web page can only imagine what menus and links are to be followed for browsing his or her own web page and it is difficult to intuitively understand how the web page can be browsed.

Further, in the case of revising the once uploaded web page, it is necessary to specify the upload area of the web contents to which the revised web contents are to be uploaded, similarly to the case of newly uploading a web page. This is very troublesome for the user because the upload area of web contents has to be specified every time the once uploaded web page is to be revised.

Furthermore, since the web contents have been once stored on a local hard disk, in the case of using another personal computer for editing the web contents, it is necessary to copy the web contents under revision on a removable media or the like for transferring them to the other personal computer.

Moreover in the case where the areas to which a web page can be uploaded are established separately for each set of web contents, it is necessary to specify the upload area of the web contents for each set of web contents. However, this operation is not only troublesome but may also lead to erroneous specification of the upload area of the web contents.

### BRIEF SUMMARY OF THE INVENTION

It is therefore an object of the present invention to provide a web page uploading system which enables easy editing and uploading of a web page without specifying an upload area to which the web page is to be uploaded each time the web page is to be uploaded, a computer program for achieving the uploading system and a recording medium in which the computer program is stored.

The above object of the present invention can be accomplished by a web page uploading system in which a client computer and a web server are connected via a network and which is adapted for uploading a web page from the client computer to the web server, the client computer having area registration capability for registering an area in the web server where the web page is stored as an upload area of the web page while the web page in the web server is being browsed.

According to the present invention, since the area in the web server where the web page is stored can be automatically registered and the web page to be uploaded is automatically uploaded to the area registered as the upload area of the web page, it is possible to provide a web page uploading system which can easily edit and upload a web page without specifying the upload area of the web page each time the web page is to be uploaded.

The above object of the present invention can be also accomplished by a web page uploading system in which a client computer and a web server are connected via a network and which is adapted for uploading a web page from the client computer to the web server, the client computer having area registration capability for registering an area in the web server where the web page is stored as an upload area of the web page when a software tool for web page editing is launched while the web page in the web server is being browsed and upload capability for uploading the web page edited by the software tool for web page editing to the upload area of the web.

According to the present invention, when a software tool for web page editing is launched while the web page in the web server is being browsed, the area in the web server where the web page is stored can be automatically registered and when the web page has been edited and the thus edited web page is to be uploaded, the web page is automatically uploaded to the area registered as the upload area of the web page. Therefore, it is possible to provide a web page uploading system which can easily edit and upload a web page without specifying an upload area of the web page each time the web page is to be uploaded.

In a preferred aspect of the present invention, the client computer is capable of obtaining data regarding the web page being browsed and causing the software tool for web page editing to edit the web page.

According to this preferred aspect of the present invention, when a software tool for web page editing is launched while the web page in the web server is being browsed, the web page is automatically downloaded to enable a web edit mode and when the web page has been edited and the thus edited web page is to be uploaded, the web page is automatically uploaded to the area registered as the upload area of the web page. Therefore, it is possible to more easily edit and upload a web page.

The above object of the present invention can be also accomplished by a web page uploading system in which a client computer and a web server are connected via a network and which is adapted for uploading a web page from the client computer to the web server, the client computer being capable of launching a software tool for web page editing when a link means provided on the web page is selected while the web page in the web server is being browsed, having area registration capability for registering the area in a web server pointed to by the link means as an upload area of the web page and having upload capability for uploading the web page edited by the software tool for web page editing to the upload area of the web page.

According to the present invention, when a link means is selected and a software tool for web page editing is launched, the area in the web server pointed to by the link means as an upload area of the web page is automatically registered and when the web page has been edited and the thus edited web page is to be uploaded, the web page is automatically uploaded to the area registered as the upload area of the web page. Therefore, it is possible to provide a web page uploading system which can easily edit and upload a web page without specifying an upload area of a web page each time the web page is to be uploaded.

In a preferred aspect of the present invention, the client computer is capable of obtaining data regarding the web page of the area pointed to by the link means and causing the software tool for web page editing to edit the web page.

According to this preferred aspect of the present invention, when a software tool for web page editing is launched while the web page in the web server is being browsed, the web page of the area pointed to by the link means is automatically downloaded to enable a web edit mode and when the web page has been edited and the thus edited web page is to be uploaded, the web page is automatically uploaded to the area registered as the upload area of the web page. Therefore, it is possible to more easily edit and upload a web page.

In a further preferred aspect of the present invention, the web server includes a list in which web page editorial authorization is registered for individual users and the link means consist solely of link means pointing to web pages for which the individual users have editorial authority.

According to this preferred aspect of the present invention, since authorization to access each web page is restricted based on the editorial authority of the user with respect to the web page taking into account that the editorial authority with respect to each web page depends upon the user, and the software tool for web page editing is launched only for a web page with respect to which the user has editorial authority, each of the users can edit a web page without being concerned about his or her own editorial authority with respect to the web page and it is therefore possible for each user to select a web page which he or she has authority to edit without confusion.

In a further preferred aspect of the present invention, the client computer has storage capability for storing a web page in the upload area after the start of editing by the software tool for web page editing and prior to uploading.

According to this preferred aspect of the present invention, since a web page being edited is not stored on the local hard disk but is stored at a specific area in the web server, it is possible to edit the web page from any client computer connected to the network so long as the client computer is logged onto the network and it is therefore possible to more easily edit and upload a web page.

The above object of the present invention can be also accomplished by a computer program for enabling a client computer connected to a web server via a network to register a specific area in the web server as an upload area of a web page where the web page is stored when a software tool for web page editing is launched while the web page in the web server is being browsed and to upload the web page edited by the software tool for web page editing to the upload area of the web page.

According to the present invention, when a software tool for web page editing is launched while the web page in the web server is being browsed, the area in the web server where the web page is stored can be automatically registered and when the web page has been edited and the thus edited web page is to be uploaded, the web page is automatically uploaded to the area registered as the upload area of the web page. Therefore, it is possible to provide a computer program which can easily edit and upload a web page without specifying an upload area of a web page each time the web page is to be uploaded.

The above object of the present invention can be also accomplished by a computer program for enabling a client computer connected to a web server via a network to launch a software tool for web page editing when a link means is selected on a web page in the web server being browsed, to register a specific area pointed to by the link means as an upload area of a web page and to upload the web page edited by the software tool for web page editing to the upload area of the web page.

According to the present invention, when a link means is selected and a software tool for web page editing is launched, the area in the web server pointed to by the link means as an upload area of the web page is automatically registered and when the web page has been edited and the thus edited web page is to be uploaded, the web page is automatically uploaded to the area registered as the upload area of the web page. Therefore, it is possible to provide a computer program which can easily edit and upload a web page without specifying the upload area of the web page each time the web page is to be uploaded.

The above object of the present invention can be also accomplished by a computer-readable recording medium in which is recorded a computer program for enabling a client computer connected to a web server via a network to register a specific area in the web server as an upload area of a web page where the web page is stored when a software tool for web page editing is launched while the web page in the web server is being browsed and to upload the web page edited by the software tool for web page editing to the upload area of the web page.

According to the present invention, when a software tool for web page editing is launched while the web page in the web server is being browsed, the area in the web server where the web page is stored can be automatically registered and when the web page has been edited and the thus edited web page is to be uploaded, the web page is automatically uploaded to the area registered as the upload area of the web page. Therefore, it is possible to provide a computer program which can easily edit and upload a web page without specifying the upload area of the web page each time the web page is to be uploaded.

The above object of the present invention can be also accomplished by a recording medium which can read using a computer a computer program for enabling a client computer connected to a web server via a network to launch a software tool for web page editing when a link means is selected on a web page in the web server being browsed, to register a specific area pointed to by the link means as an upload area of a web page and to upload the web page edited by the software tool for web page editing to the upload area of the web page.

According to the present invention, when a link means is selected and a software tool for web page editing is launched, the area in the web server pointed to by the link means as the upload area of the web page is automatically registered and when the web page has been edited and the thus edited web page is to be uploaded, the web page is automatically uploaded to the area registered as the upload area of the web page. Therefore, it is possible to provide a computer program which can easily edit and upload a web page without specifying an upload area of the web page each time the web page is to be uploaded.

### BRIEF DESCRIPTION OF THE SEVERAL VIEWS OF THE DRAWINGS

FIG. 1 is a schematic view showing a client-server system to which a web page uploading method that is a preferred aspect of the present invention has been applied.

FIG. 2 is a block diagram showing a hardware configuration of a web server 101 and a client computer 102.

FIG. 3 is a view showing a software configuration of a web server 101.

FIG. 4 is a view showing a software configuration of a client computer 102.

FIG. 5 is a flow chart showing steps for uploading a web page in a first preferred embodiment of the present invention.

FIG. 6 is a flow chart showing steps for uploading a web page in a second preferred embodiment of the present invention.

FIG. 7 is a view showing one example of a screen displayed on a client computer which has been logged-in in the above mentioned web page uploading methods.

FIG. 8 is a view showing one example of a main menu screen on a client computer after log-in.

FIG. 9 is a view showing a list screen of a bulletin board which is one of the contents provided on a web site.

FIG. 10 is a view showing one example of bulletin board (BB) contents displayed on a client computer when one of titles in a list is clicked.

FIG. 11 is a flow chart showing steps for uploading a web page in a third preferred embodiment of the present invention.

### DETAILED DESCRIPTION OF THE INVENTION

Hereinafter, preferred embodiments of the present invention will be described in detail with reference to accompanying drawings.

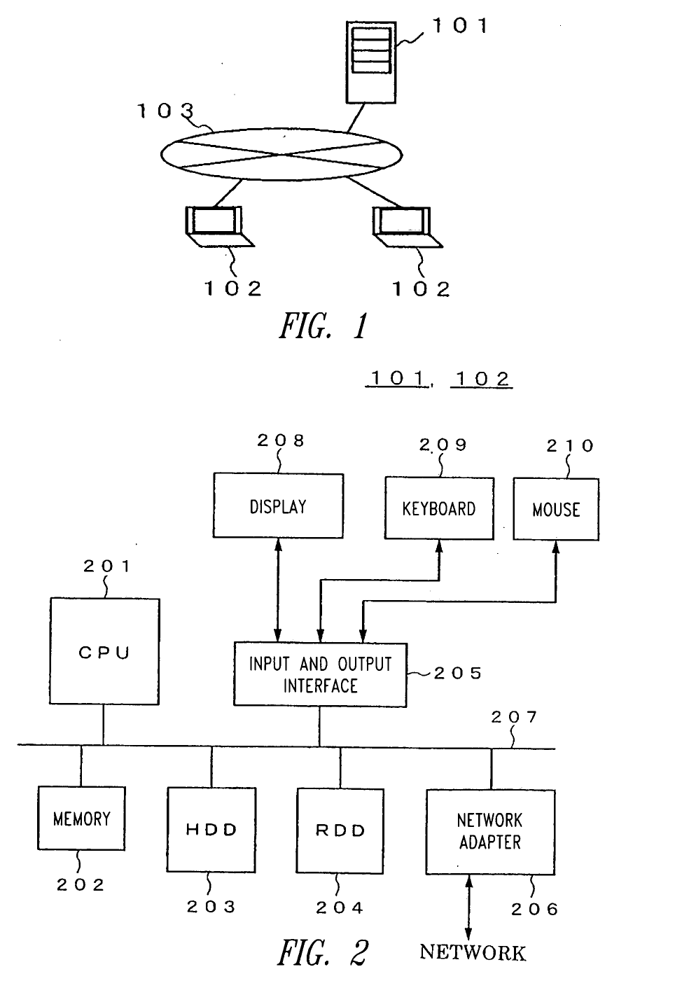

FIG. 1 is a schematic view showing a client-server system to which a web page uploading method that is a preferred aspect of the present invention has been applied.

As shown in FIG. 1, the system includes a web server 101 and a client computer 102 that are connected to a communication network such as a LAN, the Internet or the like. The web server 101 is constituted as a personal computer or a work station having a data base containing web contents. On the other hand, the client computer 102 is constituted as a personal computer having web browsing capability and web editing capability.

FIG. 2 is a block diagram showing the hardware configuration of the web server 101 and the client computer 102.

The web server 101 and the client computer 102 are constituted as computers and have the same basic configuration. As shown in FIG. 2, the web server 101 and the client computer 102 each includes a CPU 201, a memory 202, a hard drive disk (HDD) 203, a removable disk drive 204 which can reproduce data from and record data to recording media such as a flexible disk, a CD-ROM, a CD-R, a DVD-ROM or the like, an input and output interface 205 and a network adapter 206, which are connected via a bus 207. The web server 101 and the client computer 102 are each connected via the input and output interface 205 to a display 208, a keyboard 209, a mouse 210 and the like and are each connected via the network adapter 206 to a communication network 103.

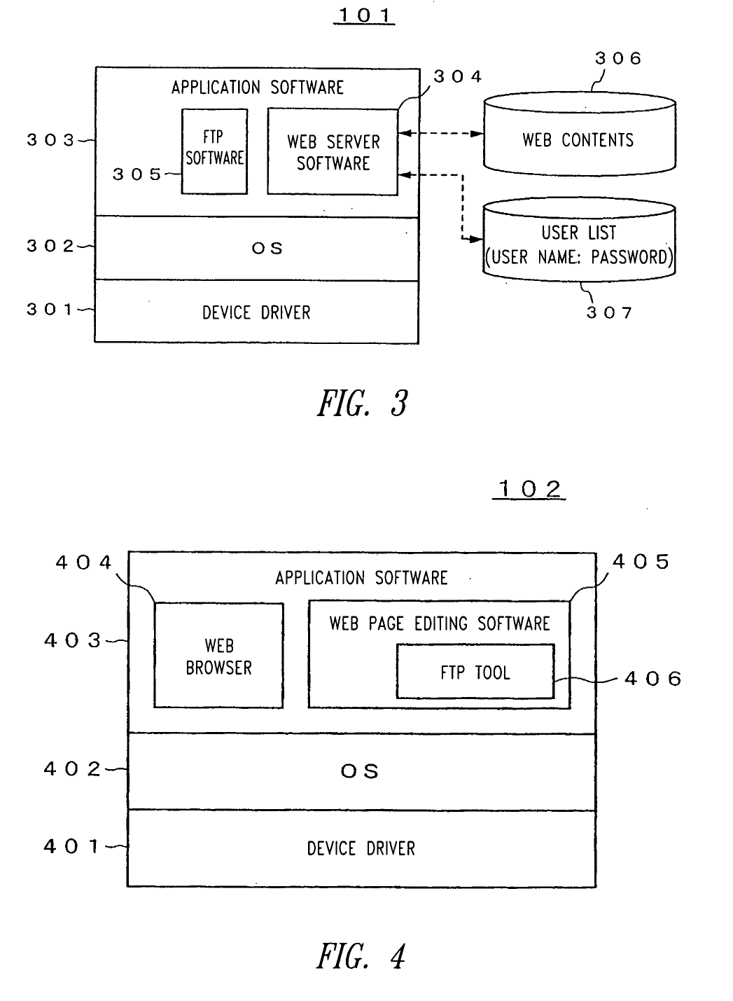

FIG. 3 is a view showing the software configuration of the web server 101.

As shown in FIG. 3, the web server 101 includes a device driver 301, an operating system 302 and application software 303. As the application software 303, web server software 304, FTP software 305 and the like are installed. The web server 101 uses the web server software 304 to transmit web contents stored therein in response to requests from the client computer 102 and launches a script. Further, the web server 101 uses the FTP software 305 to receive web page uploads. Various programs other than the web server software 304 and the FTP software 305 may be installed in the web server 101.

Moreover, the web server 101 is provided with a user list 307 including user names and passwords for receiving the data base 306 of web contents to be provided and log-ins from the client computer 102.

FIG. 4 is a view showing the software configuration of the client computer 102.

As shown in FIG. 4, the client computer 102 includes a device driver 401, an operating system (OS) 402 and application software 403. As the application software 403, a web browser 404 for achieving a web page browsing function and a web editing program 405 for achieving a web page editing function, and the web editing program 405 includes a software tool 406 for achieving an FTP function. The browsing, editing and uploading of a web page can be achieved using these programs.

Each of the functions of the web server 101 and the client computer 102 can be achieved by installing the corresponding program in the hard disk drive 203 of the computer, reading it from the hard disk drive 203 when the computer is started or when the program is executed, loading it in the memory 202, and sequentially having the CPU 201 execute programs in accordance with the software loaded in the memory 202.

These programs are supplied in the form of a recording medium such as a CR-ROM storing them, for example. When the recording medium is set in the removable disk drive 204 and an installing operation is performed, the software is stored on the hard disk drive 203 and installed in the web server 101 or the client computer 102. Further, various kinds of software may be downloaded into the web server 101 or the client computer 102 via the Internet. In this case, the software is downloaded via the network adapter 206 and installed in the web server 101 or the client computer 102.

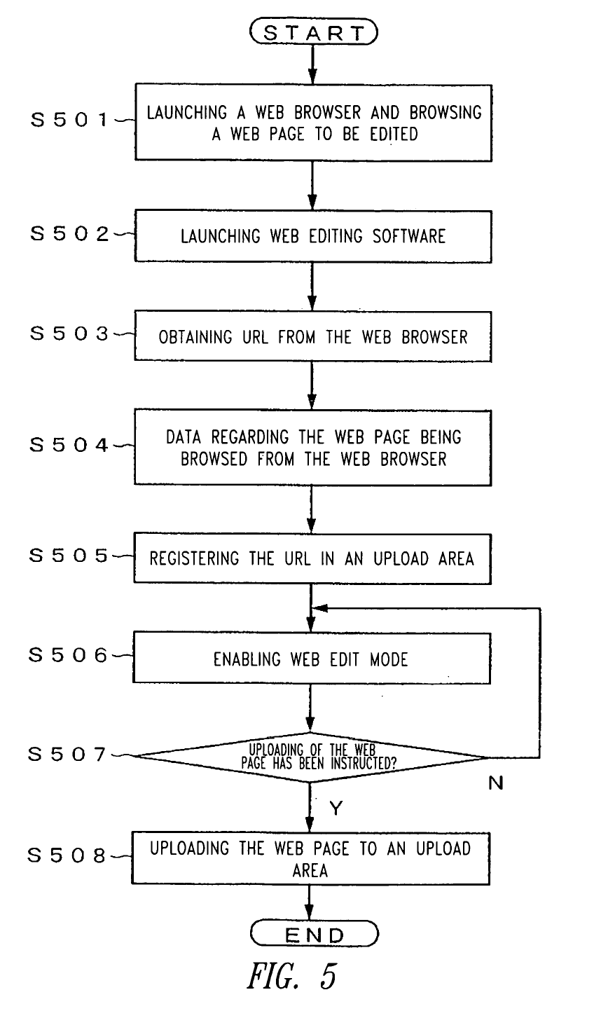

FIG. 5 is a flow chart showing steps for uploading a web page in a first preferred embodiment of the present invention.

As shown in FIG. 5, the web browser is first launched by the user and a web page to be edited is browsed (S501). The web editing program is then launched while the web page is being browsed (S502). It is preferable for the web editing program to be launchable by clicking an icon button provided on an operation screen of the web browser because this makes the web editing program easy to launch.

When the web editing program is launched, the URL of an upload area and a web page to be edited are first obtained (S503 and S504). Since the URL of the web page, an HTML file and an image file constituting the web page are cached in the web browser, these data can be obtained from the web browser when the web page to be edited is being browsed by the web browser.

The URL obtained from the web browser is registered as an upload area of the web page to be edited in a web editing mode (S505). On the other hand, data such as an HTML file and the like obtained from the web browser are displayed in the editing screen of the web editing program and a web editing mode is enabled (S506). Thus, the user can edit the web page on the editing screen.

When the web page has been edited by the user and uploading is instructed using the FTP tool incorporated in the web editing program (S507Y), the edited web page is uploaded to the URL registered at the step S505 as the upload area of the web page (S508). Since the upload area of the web page has been already specified by launching the web editing program while the web page was being browsed, it is possible for the user to upload the web page with a simple operation without specifying the upload area of the web page.

In the case of newly adding a web page instead of editing an uploaded web page, the following operation is conducted.

The user first launches the web browser and browses a web page in the same directory as that in which a new web page is to be stored and then launches the web editing program. When the web editing program is launched, the URL of an upload area and the web page to be edited are obtained.

Here, since a web page is to be uploaded to substantially the same area, the URL is registered without being corrected as the upload area of the web page. To the contrary, although a web page having no direct relation with a new web page is displayed on the editing screen, it is possible to produce a new web page without any particular trouble by clearing the web page displayed on the editing screen, newly producing a web page and starting to edit a blank web page or template.

In this manner, even in the case of newly producing a web page, it is possible for the user to upload the web page with a simple operation without specifying the upload area of the web page.

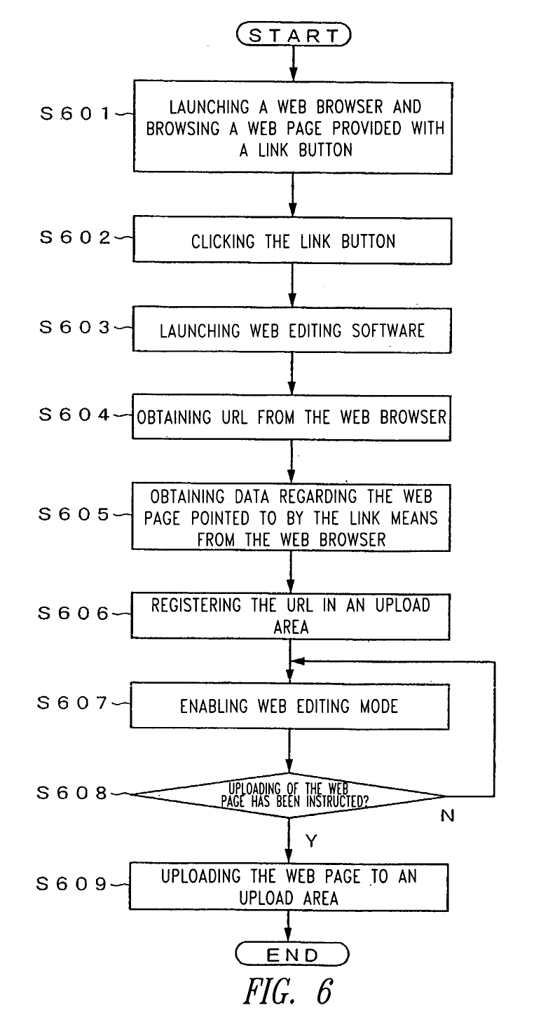

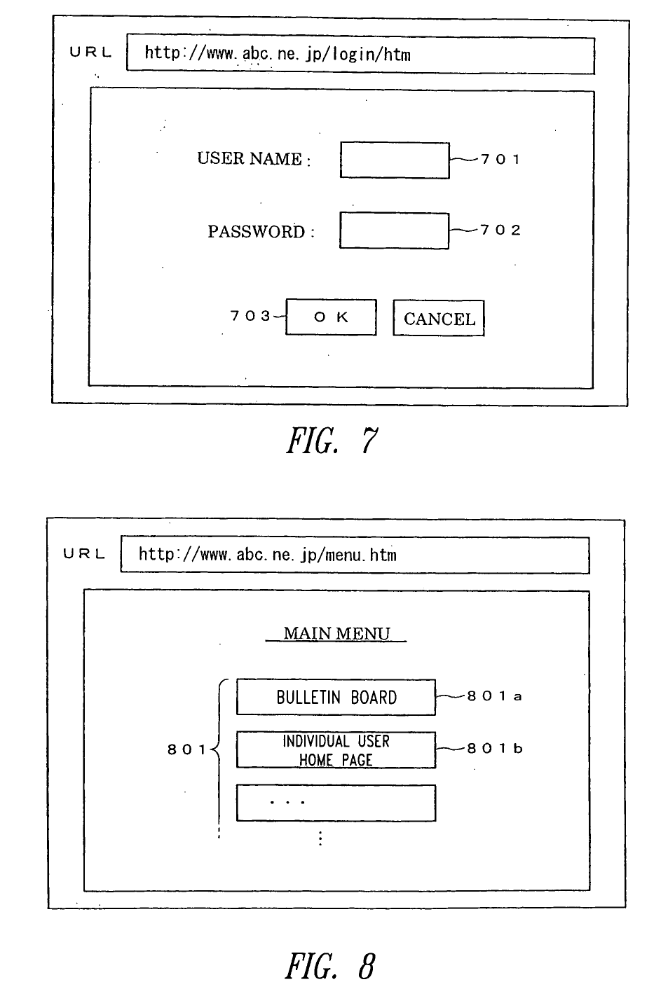

FIG. 6 is a flow chart showing steps for uploading a web page in a second preferred embodiment of the present invention.

In this embodiment, the editing of another web page in a linked area is performed by clicking a link button provided on a web page while the web page is being browsed.

As shown in FIG. 6, the user launches a web browser and browses a predetermined web page provided with a link button linked with the web page to be edited (S601). When a predetermined link button provided on the web page is clicked (S602), a script associated with the link button is executed, whereby a web editing program is automatically launched (S603).

When the web editing program is automatically launched, the URL of an upload area and the web page to be edited are first obtained (S604 and S605). When the link button linked with the web page to be edited is clicked, since the screen jumps to the web page to be edited and the URL of the web page, an HTML file and an image file constituting the web page are cached in the web browser, these data can be obtained from the web browser.

The URL obtained from the web browser is registered as an upload area of the web page to be edited in a web editing mode (S606). On the other hand, data such as an HTML file and the like obtained from the web browser are displayed in the editing screen of the web editing program and a web editing mode is enabled (S607). Thus, an editing mode is enabled and the user can edit the web page on the editing screen.

When the web page has been edited by the user and uploading is instructed using the FTP tool incorporated in the web editing program (S608Y), the edited web page is uploaded to the URL registered at the step S606 as the upload area of the web page (S609). Since the upload area of the web page has been already specified by launching the web editing program while the web page was being browsed, it is possible for the user to upload the web page with a simple operation without specifying the upload area of the web page.

The web page uploading methods shown in FIGS. 5 and 6 are preferably performed only by the user with authority to change the contents of the web page. In order to judge whether or not the user has such editing authority, it is necessary to have the user log onto a web site, find web pages whose contents can be changed by the user based on the log-in information and allow the user to edit and upload only the thus found web pages. Further, since a plurality of sets of contents are supplied from a single web site, in the case where directories are established separately for each of set of contents, it is preferable to register the upload area of a web page in accordance with its contents. A thus constituted third preferred embodiment will be explained below using one example of a screen displayed on the client computer.

FIG. 7 is a view showing one example of a screen displayed on the client computer which has been logged-in in the above mentioned web page uploading methods.

When a web browser of the client computer has been launched and a web site whose URL is http://www.abc.ne.jp/ has been accessed, the web server jumps from the web site having the above mentioned URL to that having another URL and supplies a log-in screen to the client computer. At this time, the URL is represented by http://www.abc.ne.jp/login.htm, for example.

As shown in FIG. 7, in the log-in screen, a text box 701 for inputting a user name and a text box 702 for inputting a password are displayed. When the user name and the password are input by the user and an “OK” button 703 is clicked, the thus input user name and password are transmitted to the web server. After the web server has authenticated the user name and the password, it permits the user to log in.

FIG. 8 is a view showing one example of a main menu screen on the client computer after log-in.

As shown in FIG. 8, at this time, the URL is represented by http://www.abc.ne.jp/menu.htm login.htm, for example, and link buttons 801 for selecting various contents such as a bulletin board, home pages of individual users and the like are displayed in the main menu screen. When the user clicks one of the link buttons 801, a web page of the corresponding contents is displayed. For example, when the “BB” button 801a is clicked by the user, the main screen of the bulletin board is displayed and when the “Individual User Home Page” button 801b is clicked by the user, the main screen of the home pages is displayed.

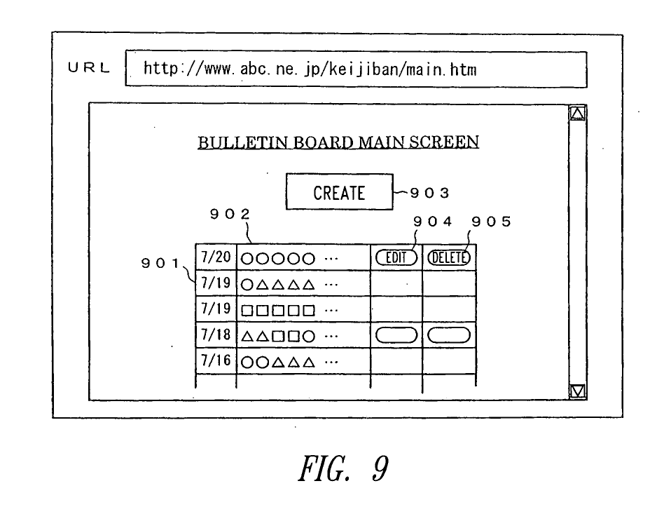

FIG. 9 is a view showing a list screen of the bulletin board which is one of the contents provided on the web site.

As shown in FIG. 9, at this time, the URL is represented by http://www.abc.ne.jp/keijiban/list.htm, for example, and a list 901 of bulletin board (BB) contents posted by a number of users is displayed in the main screen of the bulletin board. When the user clicks one of titles 902 indicated in the list 901, he or she can see the BB contents corresponding thereto.

Further, a “Create” button 903 used for newly producing BB contents is provided in the list screen and the user can newly produce BB contents by clicking this button. Moreover, the user can edit and delete the BB contents he or she created and in the case where there are BB contents which can be edited or deleted, an “Edit” button 904 and a “Delete” button are also displayed on one side of the title. Furthermore, as shown in FIG. 9, in the case where the user does not have authority to edit the BB contents, none of these buttons is displayed. Whether or not the user has an editing authority is judged by checking the login user name and the user name under which the BB contents contained in the data constituting the BB contents was produced. The user having editing authority can edit BB contents by clicking the corresponding “Edit” button 904 and can delete BB contents by clicking the corresponding “Delete” button.

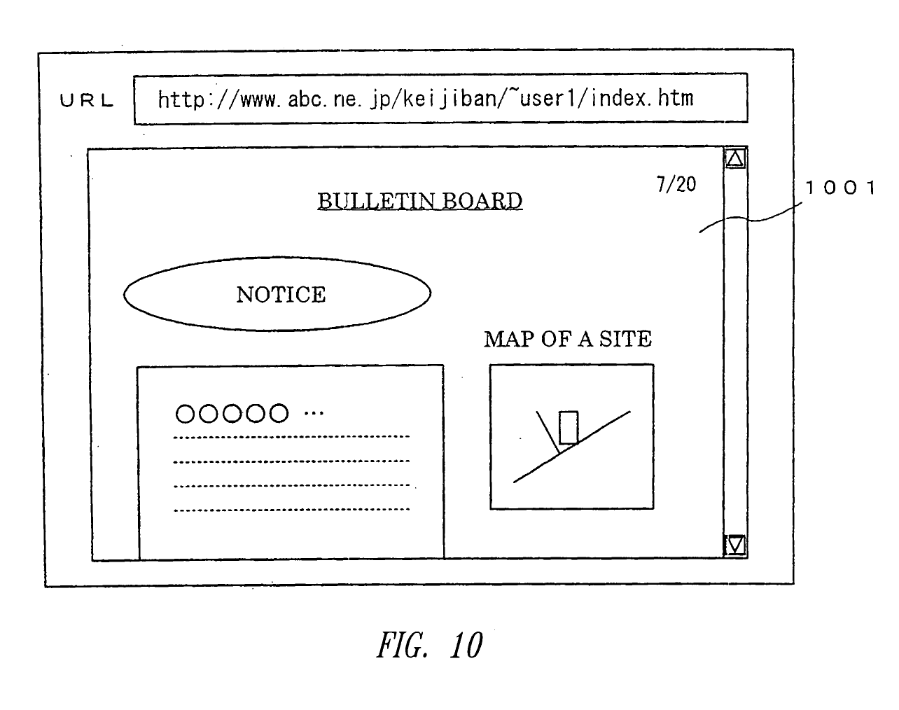

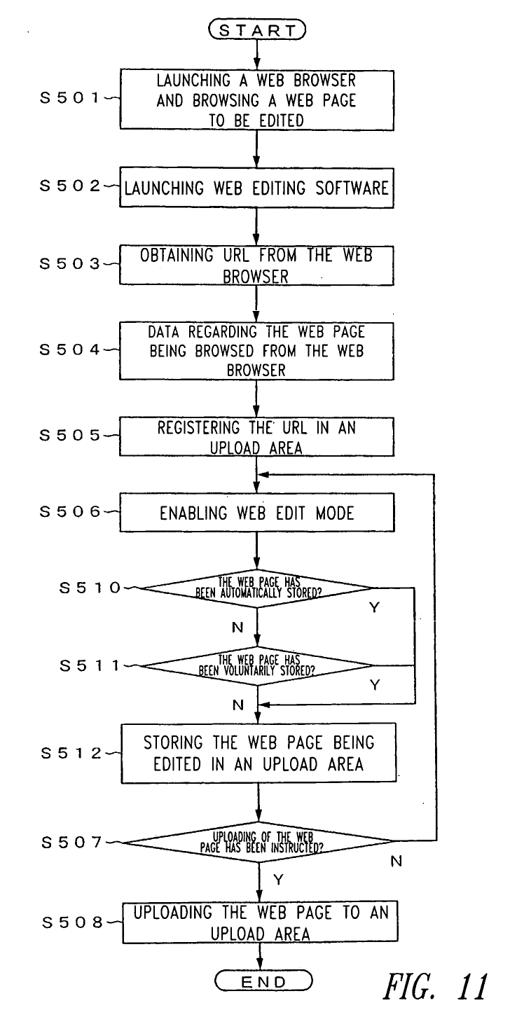

FIG. 10 is a view showing one example of BB contents displayed on the client computer when one of the titles in the list is clicked.

As shown in FIG. 10, at this time, the URL is represented by http://www.abc.ne.jp/keijiban/˜user1/page1.htm, for example, and BB contents 1001 produced by the user and having the user name “user1” are displayed.

When an “Edit” button 904 for editing BB contents 1001 is clicked in the main screen of the bulletin board shown in FIG. 9, a script associated therewith is executed, whereby a web editing program is launched. The web editing program first obtains the URL of a web page and an HTML file and the like from a web browser.

Since a URL of the web page, an HTML file and an image file constituting the web page are cached in the web browser, these data can be obtained from the web browser when the “Edit” button 904 linked with the web page of the BB contents 1001 shown in FIG. 10 is clicked.

The thus obtained URL is registered as an upload area of the edited web page by the FTP tool incorporated in the web editing program. On the other hand, data such as an HTML file and the like obtained from the web browser are displayed in the editing screen of the web editing program and a web editing mode is enabled. In the web editing mode, when the web page has been edited by the user and the uploading of the web page is instructed, the upload area of the web page is identified from the URL and the web page is uploaded to the thus identified upload area.

In this manner, since the user name and the password are obtained when the client computer logs on and based on the user name and the password, the web editing program is launched only for the web pages which the user has authority to edit, so that only the web page which the user has authority to access can be edited. Further, when the web editing tool is launched after log-in, the web page is automatically downloaded to enable an editing mode and when the editing of the web page has been completed and the thus edited web page is uploaded, the web page is automatically uploaded to the area registered as an upload area of the web page. Therefore, since it is possible to remove the burden of repeatedly specifying an upload area of a web page, it is possible to provide a tool by which maintenance can be effected on a web page in a desired manner.

When the “Create” button 903 for newly producing BB contents 1001 is clicked in the main screen of the bulletin board shown in FIG. 9, a script associated therewith is executed, whereby a web editing program is launched. The web editing program first produces a new URL based on the URL associated with the “Create” button 903 and the log-in user name. For example, based on the URL “http://www.abc.ne.jp/keijibanf/” associated with the “Create” button 903 and the user name “user1”, a URL “http://www.abc.ne.jp/keijiban/˜user” is identified as an upload area of a web page.

The thus newly produced URL is registered as an upload area of the edited web page by the FTP tool incorporated in the web editing program.

On the other hand, the web editing program displays a blank web page on the editing screen or selects a desired template file from a group of template files to enable a web editing mode. In the web editing mode, when the web page has been edited by the user and the uploading of the web page is instructed, the upload area of the web page is identified from the URL and the web page is uploaded to the thus identified upload area.

In this manner, when the web editing tool is launched at an area where the user wishes to store a new web page, the area is once registered by the web editing tool and when a web page is produced and the produced web page is uploaded, the web page is automatically uploaded to the area obtained as an upload area of the web page. Therefore, even in the case where web pages have hierarchical structures over a plurality of pages and include complicated links, it is possible for the user to intuitively grasp beforehand where the his or her own web page is stored among the all web pages and what menus lead to the user's own web page. Therefore, it is possible to provide a tool by which maintenance can be effected on a web page in a desired manner.

In this preferred embodiment, although a web page being edited is stored on the local hard disk of the client computer and is not stored on the web server until uploading is performed, a web page being edited may be stored on the web server.

FIG. 11 is a flow chart showing steps for uploading a web page in a third preferred embodiment of the present invention. Here, explanation about the same steps as those in FIG. 5 will be omitted.

As shown in FIG. 11, when a web editing mode is enabled (S506), the user can edit a web page on the editing screen and at the same time, the web page being edited is automatically stored as a temporary file at a specific area in the web server which is an upload area of the web page (S510Y and S512). This automatic storing of a web page is repeated at regular intervals. In the case where the user voluntarily stores a web page being edited, a specific area in the web server is specified as an upload area of the web page and the web page being edited is stored on the web server (S511Y and S512).

Thereafter, when the uploading of the edited web page is instructed by the user (S507Y), the web page is uploaded to the URL registered at the step S505 as an upload area of the web page (S508).

In the case where the web page being edited is preliminary stored on the web server in this manner after the program tool for web page editing started to edit the web page and before the web page is uploaded, it is possible to directly access a web file stored at the area reserved in the web server from any one of the client computers without employing a removable disk and transferring the web page being edited to another client computer and edit the web page. In this case, the area in the web server to which the edited web page is to be actually uploaded may be used as a preliminary storing area or it is possible to reserve a separate area exclusively used as a preliminary storing area in the web server.

The present invention has thus been shown and described with reference to specific embodiments. However, it should be noted that the present invention is in no way limited, to the details of the described arrangements but changes and modifications may be made without departing from the scope of the appended claims.

For example, in the above described preferred embodiments, although the explanation was made as to the case where the web page is compiled using HTML, it is not absolutely necessary to compile a web page using HTML and a web page may be compiled using any language such as SGML, XML or the like.

Further, in the above described preferred embodiments, although the explanation was made as to the case where two kinds of software, namely, the web browser for browsing a web page and the web editing program for editing and uploading a web page are installed and the FTP tool is incorporated in the web editing program, application of the present invention is not limited to this case and it is possible to install an independent program for each function or a single program integrating the three functions.

As described above, according to the present invention, it is possible to provide a web page uploading system which enables easy editing and uploading of a web page without specifying an upload area to which the web page is to be uploaded each time the web page is to be uploaded, a computer program for achieving the upload system and a recording medium in which the computer program is stored.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A web page uploading system in which a client computer and a web server are connected via a network and which is adapted for uploading a web page from the client computer to the web server, the client computer having area registration capability for registering an area in the web server where the web page is stored as an upload area of the web page while the web page in the web server is being browsed.

2. A web page uploading system in which a client computer and a web server are connected via a network and which is adapted for uploading a web page from the client computer to the web server, the client computer having area registration capability for registering an area in the web server where the web page is stored as an upload area of the web page when a software tool for web page editing is launched while the web page in the web server is being browsed and upload capability for uploading the web page edited by the software tool for web page editing to the upload area of the web.

3. A web page uploading system in accordance with claim 2, wherein the client computer is capable of obtaining data regarding the web page being browsed and causing the software tool for web page editing to edit the web page.

4. A web page uploading system in which a client computer and a web server are connected via a network and which is adapted for uploading a web page from the client computer to the web server, the client computer being capable of launching a software tool for web page editing when a link means provided on the web page is selected while the web page in the web server is being browsed, having area registration capability for registering the area in a web server pointed to by the link means as an upload area of the web page and having upload capability for uploading the web page edited by the software tool for web page editing to the upload area of the web page.

5. A web page uploading system in accordance with claim 4, wherein the client computer is capable of obtaining data regarding the web page of the area pointed to by the link means and causing the software tool for web page editing to edit the web page.

6. A web page uploading system in accordance with claim 4, wherein the web server includes a list in which web page editorial authorization is registered for individual users and the link means consist solely of link means pointing to web pages for which the individual users have editorial authority.

7. A web page uploading system in accordance with claim 5, wherein the web server includes a list in which web page editorial authorization is registered for individual users and the link means consist solely of link means pointing to web pages for which the individual users have editorial authority.

8. A web page uploading system in accordance with claim 2, wherein the client computer has storage capability for storing a web page in the upload area after the start of editing by the software tool for web page editing and prior to uploading.

9. A web page uploading system in accordance with claim 3, wherein the client computer has storage capability for storing a web page in the upload area after the start of editing by the software tool for web page editing and prior to uploading.

10. A web page uploading system in accordance with claim 4, wherein the client computer has storage capability for storing a web page in the upload area after the start of editing by the software tool for web page editing and prior to uploading.

11. A web page uploading system in accordance with claim 5, wherein the client computer has storage capability for storing a web page in the upload area after the start of editing by the software tool for web page editing and prior to uploading.

12. A web page uploading system in accordance with claim 6, wherein the client computer has storage capability for storing a web page in the upload area after the start of editing by the software tool for web page editing and prior to uploading.

13. A web page uploading system in accordance with claim 7, wherein the client computer has storage capability for storing a web page in the upload area after the start of editing by the software tool for web page editing and prior to uploading.

14. A computer program for enabling a client computer connected to a web server via a network to register a specific area in the web server as an upload area of a web page where the web page is stored when a software tool for web page editing is launched while the web page in the web server is being browsed and to upload the web page edited by the software tool for web page editing to the upload area of the web page.

15. A computer program for enabling a client computer connected to a web server via a network to launch a software tool for web page editing when a link means is selected on a web page in the web server being browsed, to register a specific area pointed to by the link means as an upload area of a web page and to upload the web page edited by the software tool for web page editing to the upload area of the web page.

16. A computer-readable recording medium in which is recorded a computer program for enabling a client computer connected to a web server via a network to register a specific area in the web server as an upload area of a web page where the web page is stored when a software tool for web page editing is launched while the web page in the web server is being browsed and to upload the web page edited by the software tool for web page editing to the upload area of the web page.

17. A recording medium which can read using a computer a computer program for enabling a client computer connected to a web server via a network to launch a software tool for web page editing when a link means is selected on a web page in the web server being browsed, to register a specific area pointed to by the link means as an upload area of a web page and to upload the web page edited by the software tool for web page editing to the upload area of the web page.
